(19) United States
(12) Patent Application Publication
(10) Pub. No.: US 2008/0032644 A1
(43) Pub. Date: Feb. 7, 2008

(54) Automatic linear transmitter spectral optimization using transistor bias adjustment

(75) Inventor: Jeffrey K. Hunter, Olathe, KS (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/492,538

(22) Filed: Jul. 24, 2006

(51) Int. Cl. H04B 1/04; H01Q 11/12

(52) U.S. Cl. 455/127.1

(57) ABSTRACT

A system for spectral optimization of a transmitter includes a signal generating device configured to generate an analog transmitter signal. An amplifier is coupled to the signal generating device and is configured to amplify the analog transmitter signal. An A/D converter is coupled to the amplifier and is configured to convert an output of the amplifier to digital data samples. A digital signal processor is coupled to the A/D converter. The digital signal processor is configured to receive digital data samples from the A/D converter, to compute a fast Fourier transform spectrum, to compare the fast Fourier transform spectrum to spectral limits, and to generate a control signal to adjust the fast Fourier transform spectrum to meet the spectral limits.

### FIELD OF THE INVENTION

The present invention relates to the field of RF transmitters and, more specifically, to an automatic linear transmitter spectral optimization using transistor bias adjustment.

### BACKGROUND OF THE INVENTION

Radio frequency (RF) transmitters are designed to transmit within certain fixed channels. In order to avoid interference in adjacent channels, RF transmitters are subject to stringent spectral requirements, which limit the amount of energy that can be produced in adjacent channels. In order to satisfy the spectral requirements, the transistors in the amplifiers of the RF transmitter have their biases adjusted when manufactured. For example, the bias of the transistor is set by adjusting a potentiometer to adjust the bias voltage of the transistor.

While the above approach limits energy transmitted in adjacent channels, it does not optimize the spectral performance of a RF transmitter. In addition, over time the bias setting can drift, changing the performance of the transmitter.

Accordingly, it is desired to provide automatic linear transmitter spectral optimization using transistor bias adjustment. Furthermore, the desirable features and characteristics of the present invention will be apparent from the subsequent detailed description and the appended claims, taken in conjunction with the accompanying drawings and the foregoing technical field and background.

### BRIEF SUMMARY OF THE INVENTION

In one embodiment of the present invention a method for determining spectral optimization of a transmitter comprises a first step of receiving digital data samples representative of the transmitter output. Next, a fast Fourier transform is performed on the data sample to determine a fast Fourier transform spectrum. The fast Fourier transform spectrum is compared to a predetermined adjacent channel power limit. A bias on a transistor of an amplifier of the transmitter is adjusted to reduce the fast Fourier transform spectrum below the adjacent channel power limit, if the adjacent channel power limit was exceeded by the fast Fourier transform spectrum.

In another embodiment, a system for spectral optimization of a transmitter includes a signal generating device configured to generate an analog transmitter signal. An amplifier is coupled to the signal generating device and is configured to amplify the analog transmitter signal. An A/D converter is coupled to the amplifier and is configured to convert an output of the amplifier to digital data samples. A digital signal processor is coupled to the A/D converter. The digital signal processor is configured to receive digital data samples from the A/D converter, to compute a fast Fourier transform spectrum, to compare the fast Fourier transform spectrum to spectral limits, and to generate a control signal to adjust the fast Fourier transform spectrum to meet the spectral limits.

### BRIEF DESCRIPTION OF THE DRAWINGS

The present invention will hereinafter be described in conjunction with the following drawing figures, wherein like numerals denote like elements, and:

FIG. 1 illustrates a block diagram of an exemplary RF transmitter in accordance with the teachings of the present invention;

FIG. 2 is a flowchart of an exemplary method for spectral optimization of a transmitter in accordance with the teachings of the present invention;

FIGS. 3a and 3b illustrate exemplary embodiments of a fast Fourier transform spectrum and a predetermined adjacent channel power limit in accordance with the teachings of the present invention; and

FIGS. 4a and 4b are exemplary embodiments of spectrums of an AM modulated signal in accordance with the teachings of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

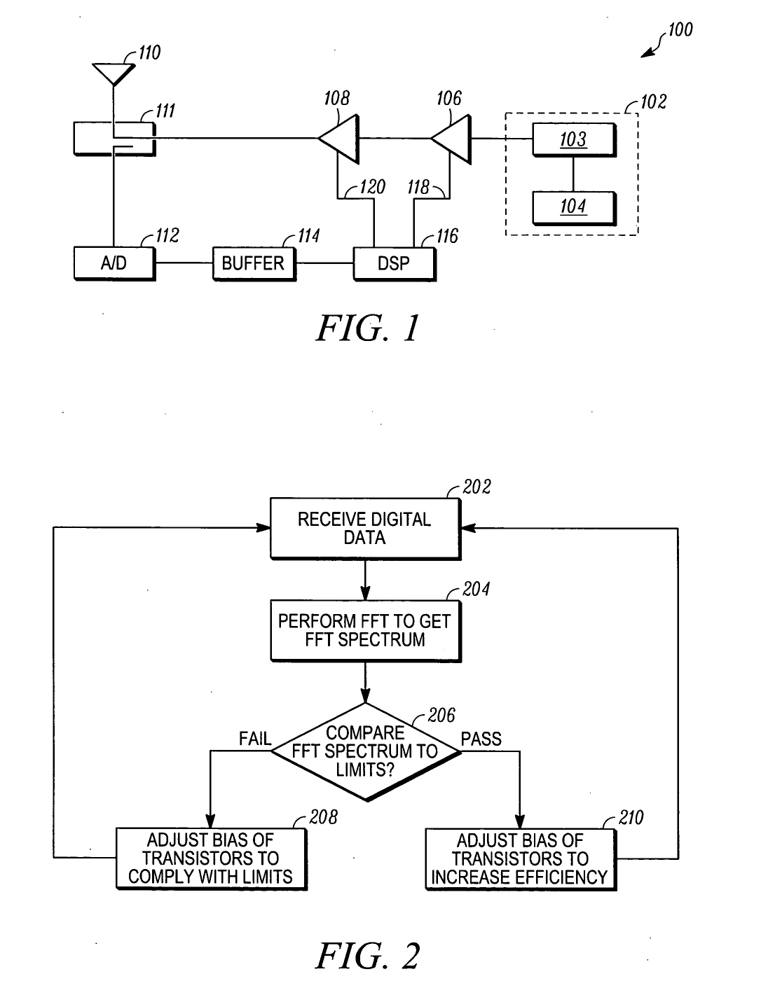

FIG. 1 is a block diagram of an exemplary embodiment of a transmitter 100 coupled to an antenna 110 in accordance with the teachings of the present invention. Transmitter 100 includes a signal generating device 102. The output of the signal generating device 102 is coupled to a first amplifier stage 106 coupled in series with a second amplifier stage 108. The output of the second amplifier stage 108 is coupled to the antenna 110.

The transmitter 100 further includes an analog-to-digital (A/D) converter 112 coupled to the antenna 110 via a coupler 111. The output of the A/D converter 112 is coupled to a buffer 114. The buffer 114 is coupled to a digital signal processor (DSP) 116. The DSP 116 couples to the first amplifier stage 106 via a first control line 118 and couples to the second amplifier stage 108 via a second control line 120.

Signal generating device 102 generates signals that can be transmitted from one aircraft to another aircraft or to a ground station. In one exemplary embodiment, the signal generating device 102 comprises a frequency synthesizer 104 coupled to a modulator 103. Frequency synthesizer 104 generates a signal waveform at a certain frequency. The frequency synthesizer 104 can include a controller (not pictured) for setting the frequency of transmission. While the signal generating device 102 is illustrated as comprising a frequency synthesizer 104, any signal generating device can be used, such as a direct digital synthesizer.

Modulator 103 modulates the synthesizer signal to encode data if necessary. If the transmitter 100 is transmitting data that does not require modulation, the modulator 103 is not used.

The output of the signal generating device 102 is amplified at the first amplifier stage 106 and the second amplifier stage 108 to increase signal strength for presentation to the antenna 110. The first amplifier stage 106 and the second amplifier stage 108 are, in one exemplary embodiment, linear power amplifiers that are comprised of a plurality of transistors to accurately amplify the output of the signal generating device 102 with a minimum of distortion.

As discussed previously, when a transmitter is sending a signal in a desired transmission channel, energy is also sent in adjacent channels due to the imperfect linear behavior of the amplifiers. The energy in adjacent channels must be minimized to reduce potential interference with other signals. In order to minimize transmissions in channels adjacent to the desired transmission channel, the bias of the transistors of the amplifiers can be adjusted. In one exemplary embodiment of the present invention, the bias of the transistors can be set by the DSP 116, as will be discussed in further detail below.

Antenna 110 receives and transmits the amplified signal. Antenna 110 can be one of many types of antennas suitable for use with the transmitter 100.

A/D converter 112 converts the output of the transmitter 100 at the antenna 110 from an analog signal to a digital signal. A/D converter 112 is coupled to the antenna 110 via the coupler 111. A/D converter 112, in one embodiment, is a high speed A/D converter 112 that can operate, in one exemplary embodiment, at 100 megasamples/per second. While the A/D converter 112 is illustrated as part of the transmitter 100, the A/D converter 112, in one exemplary embodiment, can be shared with a receiver in embodiments where the transmitter 100 is part of a transmitter/receiver (transceiver).

Buffer 114 holds a plurality of the digital samples outputted by the A/D converter 112. In one exemplary embodiment, the buffer 114 is a first in/first out (FIFO) buffer. The number of samples stored in the buffer 114 can vary based, at least in part, on the frequency at which the transmitter 100 is operating. In one exemplary embodiment, buffer 114 can be included as part of the A/D converter 112.

DSP 116 receives the data samples from the buffer 114 and determines a frequency domain representation of the data sample. The sample size needed for the fast Fourier transform (FFT) varies depending on the frequency resolution needed to view the undesired signal in adjacent channels. Thus, the more samples, the finer the resolution in resolving the amount of power contained in a narrow frequency channel or in a portion of the channel. The number of samples can vary according to the bandwidth of the modulation and the bandwidth of the frequency of the channel at which the transmitter is operating. In one exemplary embodiment, 4,096 samples are used to compute the FFT when the channel frequency spacing is 25 KHz with a modulated bandwidth of 10.5 KHz.

In one exemplary embodiment, the FFT of the sampled data is used to find the FFT spectrum of the data samples. The FFT is performed on the contents of the buffer 114, which can be sent in its entirety to the DSP 116 where the FFT can be calculated. In an alternative embodiment, a discrete Fourier transform (DFT) of the digitized data samples can be calculated to derive a frequency based spectrum of the digital data samples. The DFT tends to be more efficient when examining narrow ranges of frequencies with fine resolution.

DSP 116 can also compare the FFT spectrum of the data samples to predetermined spectral limitations. In one exemplary embodiment, the spectral limitations are based on limits for adjacent channel power (ACP). ACP is power transmitted by the transmitter 100 outside the desired transmission channel. Limits to the amount of power that can be produced outside the transmission channel can be set by regulatory agencies. The bias of one or more transistors in first amplifier stage 106 and/or second amplifier stage 108 can be adjusted such that the FFT spectrum will not exceed spectral limitations. For example, if the FFT spectrum shows power in adjacent channels exceeding a preset limit, the bias of one or more transistors in first amplifier stage 106 and/or second amplifier stage 108 can be adjusted by the DSP 116 via first control line 118 and/or second control line 120.

In one exemplary embodiment, the DSP 116 can adjust the bias of the transistors of first amplifier stage 106 and/or second amplifier stage 108 by adjusting the voltage at the transistors' gate. The DSP 116 can send commands to adjust the voltage at the transistors' gate via the first control line 118 and the second control line 120. The amount of bias adjustment can be selected to be large enough to bring the transmitter 100 below predetermined adjacent power limits but not too large to be overly detrimental to the efficiency of the transmitter. In one embodiment, digital-to-analog converters (not pictured) can be part of the DSP 116, and receive a digital signal, such as a digital command, that represents the voltage adjustment to be made. Alternatively, a digital potentiometer can be provided as part of first amplifier stage 106 and/or second amplifier stage 108. Signals sent to the digital potentiometer can adjust the settings of the transistors bias voltage.

DSP 116, in one exemplary embodiment, can be software running on a processor, a dedicated logic device such as a field programmable gate array (FPGA) or an application specific integrated circuit (ASIC) or any other device or combination of devices that can perform the FFT on sample data and compare the FFT spectrum to predetermined limits.

FIG. 2 is a flowchart illustrating an exemplary method for spectral optimization of a transmitter in accordance with the teachings of the present invention. In a first step, step 202, the digital data samples, representative of the transmitter 100 output, are received from the buffer 114. In one exemplary embodiment, the entire contents of buffer 114 are transferred to the DSP 116. The data received from the buffer 114 can be stored to a memory in the DSP 116. Alternatively, the DSP 116 can take the data samples directly from the buffer 114 and perform calculations as the data samples are received.

Next, in step 204, a FFT is performed on the data samples to produce a frequency domain representation or FFT spectrum of the output of the transmitter 100. In step 206, the FFT spectrum produced in step 204 is compared to a predetermined spectral limitation, such as limits on ACP.

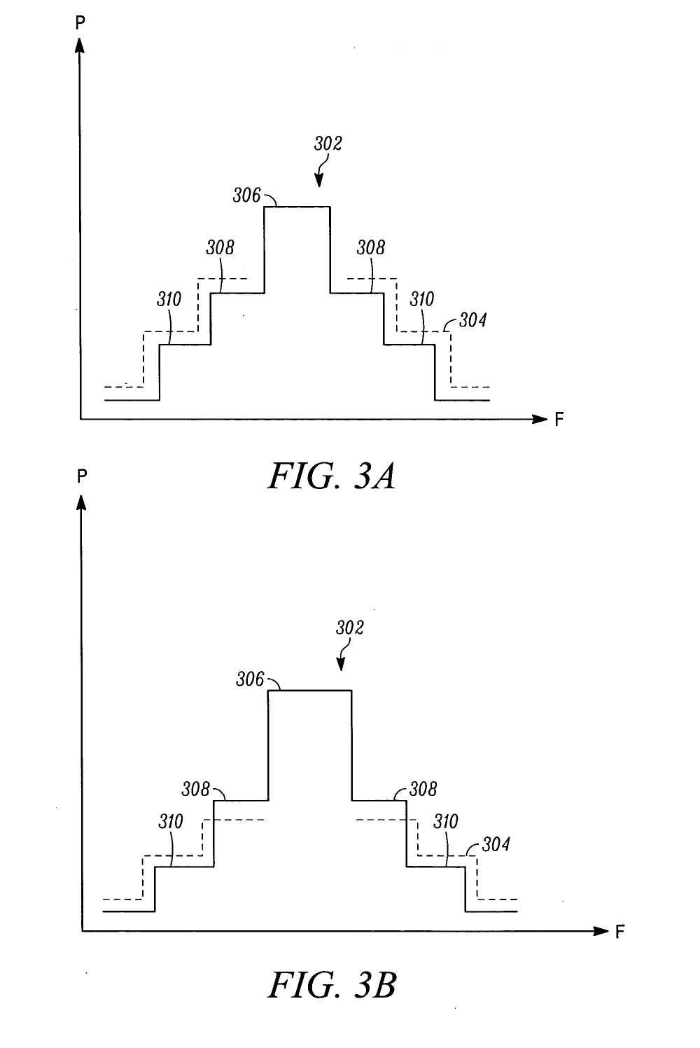

FIGS. 3a and 3b illustrate a FFT spectrum 302 and a predetermined ACP limit 304. In the embodiment shown in FIG. 3, the FFT spectrum 302 represents a differential eight phase shift keying (D8PSK) modulated signal. D8PSK modulation is used in current and proposed avionics communication systems. For example, VHF datalink (VDL) mode 2, which is an air-to-ground link and VDL mode 3, which processes voice and data channels, utilize D8PSK modulation.

As seen in FIGS. 3a and 3b, FFT spectrum 302 includes a center channel 306, a first adjacent channel 308 on either side of the center channel 306, and a second adjacent channel 310 on either side of the center channel 306.

In FIG. 3a, the FFT spectrum 302 falls below the predetermined ACP limit 304. Therefore, the FFT spectrum 302 passes the comparison with the ACP limit 304. Since the FFT spectrum 302 passes the comparison, the method continues in step 210.

In FIG. 3b, the FFT spectrum 302 in the first adjacent channel 308 exceeds the ACP limit 304. As can be seen in FIG. 3b, the power in the first adjacent channel 308 is greater than the ACP limit 304. Since the power in the first adjacent channel 308 exceeds the ACP limit 304, the comparison in step 206 fails and the method continues in step 208.

In step 208, reached after a failure in the comparison of the FFT spectrum 302 and the ACP limit 304, the bias on one or more transistors in first amplifier stage 106 and/or second amplifier stage 108 is adjusted to bring the FFT spectrum 302 under the ACP limit 304. The adjustment to the biases is done without regard to affecting the efficiency of the transmitter 100, but only with regard to adjusting the bias of one or more transistors in first amplifier stage 106 and/or second amplifier stage 108 to bring the output of the transmitter 100 into compliance with the ACP limit 304. After step 208, the process continues in step 202 where the next set of data samples is received by the DSP 116.

If, in step 206, the FFT spectrum 302 passes the comparison test, the bias of one or more transistors in the first amplifier stage 106 and/or second amplifier stage 108 can be reduced to optimize the efficiency of the power amplifiers if needed. Efficiency is maximized when the FFT spectrum 302 is close to, but does not exceed, the ACP limit 304. Again, after the biases of the transistors are adjusted, the process starts over at step 202 where the next set of data samples is received.

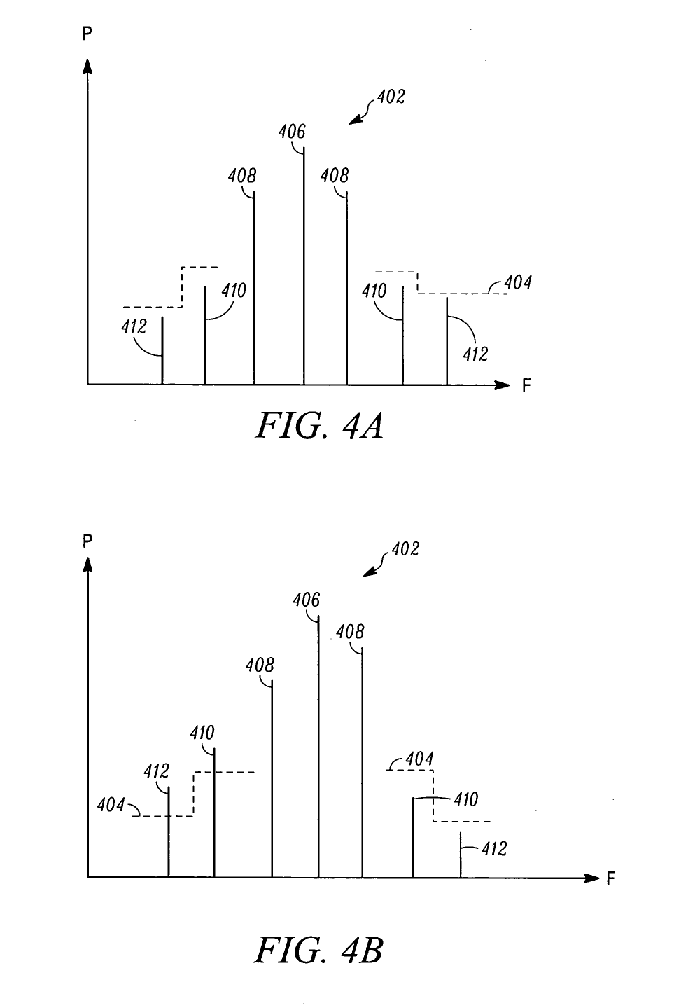

FIGS. 4a and 4b illustrate an AM modulated signal. Common to both FIG. 4a and FIG. 4b is a FFT spectrum 402 and an ACP limit 404. The FFT spectrum 402 includes a carrier frequency 406, a pair of side bands 408, a pair of first adjacent channels 410, and a pair of second adjacent channels 412 represented by lines in this modulation. FIG. 4a represents a signal that passes the comparison since the FFT spectrum 402 falls below the ACP limit 404. FIG. 4b represents a FFT spectrum 402 that fails the comparison to the ACP limit 404 since one of the second adjacent channels 412, on the left hand side of the carrier frequency 406, exceeds the ACP limit 404.

The above method can be done when the transmitter is manufactured in order to provide an initial factory setting of the transmitter. Also, the method can be done when the transmitter is in use to provide an adjustment to an operating transmitter and avoid the problems associated with transistor bias changing over time. In one exemplary embodiment, the method operates whenever the transmitter is operating, although the method could be set to run on a certain schedule. While D8PSK modulated and AM modulated signals are illustrated in FIGS. 3a, 3b, 4a and 4b, the present invention is applicable to a variety of modulations.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for spectral optimization of a transmitter comprising a signal generating device coupled to an amplifier, the method comprising:
receiving digital data samples representative of an output of the transmitter;
performing a fast Fourier transform on the digital data sample to determine a fast Fourier transform spectrum;
comparing the fast Fourier transform spectrum to a predetermined adjacent channel power limit; and
adjusting a bias of a transistor of the amplifier to reduce the fast Fourier transform spectrum below the predetermined adjacent channel power limit, if the predetermined adjacent channel power limit was exceeded by the fast Fourier transform spectrum.

2. The method of claim 1 further comprising the step of reducing the bias on the transistor, if the predetermined adjacent channel power limit was not exceeded by the fast Fourier transform spectrum.

3. The method of claim 1 wherein the step of receiving digital data samples further comprises receiving digital data samples representative of a differential eight phase shift keying modulated signal.

4. The method of claim 1 wherein the step of adjusting a bias further comprises adjusting a voltage on a gate of a transistor of the amplifier.

5. The method of claim 1 further comprising the step of storing optimal bias settings.

6. The method of claim 1 wherein the step of adjusting a bias further comprises adjusting a bias as part of an initial adjustment.

7. The method of claim 1 wherein the step of adjusting a bias further comprises adjusting the bias of a transistor as part of an in-use adjustment.

8. A system for spectral optimization of a transmitter comprising:
a signal generating device configured to generate an analog transmitter signal;
an amplifier coupled to the signal generating device and configured to amplify the analog transmitter signal;
an A/D converter coupled to the amplifier and configured to convert the analog transmitter signal to digital data samples;
a digital signal processor coupled to the A/D converter, the digital signal processor configured to:
receive the digital data samples from the A/D converter;
compute a fast Fourier transform spectrum of the digital data samples;
compare the fast Fourier transform spectrum to spectral limits; and
generate a control signal to adjust the fast Fourier transform spectrum to meet the spectral limits.

9. The system of claim 8 wherein the control signal adjusts a bias of a transistor of the amplifier.

10. The system of claim 8 wherein the signal generating device comprises a frequency synthesizer coupled to a modulator.

11. The system of claim 8 wherein the signal generating device comprises a direct digital synthesizer.

12. The system of claim 8 further comprising a first in/first out buffer coupled between the A/D converter and the digital signal processor, the first in/first out buffer configured to store the digital data samples.

13. The system of claim 8 wherein the spectral limits are an adjacent channel power limit.

14. The system of claim 8 wherein the control signal adjusts the fast Fourier transform spectrum to move the fast Fourier transform spectrum closer to the spectral limits if the fast Fourier transform spectrum falls below the spectral limits.

15. The system of claim 8 wherein the control signal adjusts the fast Fourier transform spectrum to fall below the spectral limits if the fast Fourier transform spectrum exceeded the spectral limits when compared.

16. A method for spectral optimization of a transmitter comprising:
determining a frequency domain representation of an output of the transmitter;
comparing the frequency domain representation to a predetermined spectral limit; and
generating a control signal to adjust the frequency domain representation to meet the spectral limit based on the comparison.

17. The method of claim 16 further comprising the step of receiving the control signal at an amplifier of the transmitter to adjust the bias of a transistor of the amplifier.

18. The method of claim 16 wherein the step of determining the frequency domain representation of an output of the transmitter further comprises calculating a fast Fourier transform of a digital output of the transmitter.

19. The method of claim 16 wherein the step of comparing the frequency domain representation further comprises comparing the frequency domain representation to a predetermined limitation of adjacent channel power.

20. The method of claim 17 wherein the step of receiving the control signal further comprises adjusting a voltage on a gate of the transistor of the amplifier.
